(19) United States
(12) Patent Application Publication
(10) Pub. No.: US 2024/0291827 A1
(43) Pub. Date: Aug. 29, 2024

(54) TECHNIQUES FOR VERIFYING A SENDER IDENTITY USING A USER-GENERATED IDENTIFIER

(71) Applicant: Ally Financial Inc., Detroit, MI (US)

(72) Inventors: Rustam Noshir Wadia, Charlotte, NC (US); Thomas Michael Keifer, Charlotte, NC (US)

(21) Appl. No.: 18/114,779

(22) Filed: Feb. 27, 2023

(51) Int. Cl. H04L 9/40

(52) U.S. Cl. CPC H04L 63/126; H04L 63/102

(57) ABSTRACT

Methods, systems, and devices to support techniques for verifying a sender identity using a user-generated identifier are described. A user having one or more accounts with an organization may generate a unique identifier to associate with one or more accounts, and the organization may include the unique identifier in subsequent electronic communications to the user. For example, the user may generate and transmit the unique identifier to the organization using a device, and the organization may associate the unique identifier with the one or more accounts of the user. The organization may establish a communication session with the user, such as by generating a message which includes information associated with the one or more accounts. The organization may embed the unique identifier into the message and transmit the message to the user. The message including the unique identifier may provide verification that the sender is the organization.

### FIELD OF TECHNOLOGY

The present disclosure relates generally to computer systems and software, and more specifically to techniques for verifying a sender identity using a user-generated identifier.

### BACKGROUND

Companies and organizations, such as financial institutions, may communicate with users (e.g., customers), for example, to convey account information to users or alert users of potential problems associated with user accounts. Such communications may be sent using various electronic or digital messaging techniques such as via email, push notifications, text messages, or the like. Increasingly, malicious third parties may attempt to impersonate the identity of a legitimate financial institution by sending electronic communications that appear to be from the financial institution. These malicious third parties may use such techniques in an attempt to obtain sensitive financial information from the user, such as account names, account passwords, or other private and personal information. In many cases, particularly for messages received using mobile devices, real time verification that the electronic communication is from the legitimate financial institution may be difficult. Malicious third parties may exploit this condition by sending spoofed messages (e.g., message imitating the legitimate financial institution) to unsuspecting users, which may lead to various forms of fraud to consumers.

### SUMMARY

The described techniques relate to improved methods, systems, devices, and apparatuses that support techniques for verifying a sender identity using a user-generated identifier. Generally, the described techniques provide for identifying a user-generated unique identifier and including the user-generated unique identifier in electronic communications from an organization to the user. For example, as part of one or more actions taken to set up a new account, modify an existing account, or both, a user may be given the ability to generate and transmit the unique identifier to an organization using a device (e.g., a smartphone, a tablet, a laptop computer, or the like), and the organization may then associate the user's unique identifier with one or more accounts of the user. Subsequently, the organization may establish a communication session with the user, such as by generating a message (e.g., a text message, a push notification) for communicating some information associated with the one or more accounts. The organization may embed the user's unique identifier into the message, and transmit the message to the user. After receiving the message, the user may verify (e.g., in real time) that the message includes the user-generated unique identifier, which may indicate that the received message is from the organization (e.g., and not from a malicious third party). As such, the unique identifier may serve as a secure indication that is created by the user and only known by the user and the organization and therefore non-reproducible or scalable by unauthorized third parties, thereby enhancing the security of electronic communications and enabling efficient verification of the sender of messages to include those that include private and sensitive information (e.g., personal information, financial information, request for user action).

A method is described. The method may include receiving, at a system managed by an organization, a unique identifier generated by a user and provided via a device associated with the user, the user having one or more accounts associated with the organization, establishing a communication session between the organization and the user, generating, by the system and as part of the communication session, a message associated with the one or more accounts provided by the organization, embedding the unique identifier into the message, and transmitting, as part of the communication session, the message to the device associated with the user.

An apparatus is described. The apparatus may include a processor, memory coupled with the processor, and instructions stored in the memory. The instructions may be executable by the processor to cause the apparatus to receive, at a system managed by an organization, a unique identifier generated by a user and provided via a device associated with the user, the user having one or more accounts associated with the organization, establish a communication session between the organization and the user, generate, by the system and as part of the communication session, a message associated with the one or more accounts provided by the organization, embed the unique identifier into the message, and transmit, as part of the communication session, the message to the device associated with the user.

Another apparatus is described. The apparatus may include means for receiving, at a system managed by an organization, a unique identifier generated by a user and provided via a device associated with the user, the user having one or more accounts associated with the organization, means for establishing a communication session between the organization and the user, means for generating, by the system and as part of the communication session, a message associated with the one or more accounts provided by the organization, means for embedding the unique identifier into the message, and means for transmitting, as part of the communication session, the message to the device associated with the user.

A non-transitory computer-readable medium storing code is described. The code may include instructions executable by a processor to receive, at a system managed by an organization, a unique identifier generated by a user and provided via a device associated with the user, the user having one or more accounts associated with the organization, establish a communication session between the organization and the user, generate, by the system and as part of the communication session, a message associated with the one or more accounts provided by the organization, embed the unique identifier into the message, and transmit, as part of the communication session, the message to the device associated with the user.

Some examples of the method, apparatuses, and non-transitory computer-readable medium described herein may further include operations, features, means, or instructions for transmitting, to the device associated with the user, a prompt for the unique identifier and receiving, from the device and in response to the prompt, an indication of a first identifier generated by the user, wherein the unique identifier comprises the first identifier.

Some examples of the method, apparatuses, and non-transitory computer-readable medium described herein may further include operations, features, means, or instructions for determining that the first identifier may be unique among a plurality of identifiers stored in a database of the system, wherein the unique identifier comprises the first identifier based at least in part on the first identifier being unique.

Some examples of the method, apparatuses, and non-transitory computer-readable medium described herein may further include operations, features, means, or instructions for transmitting, to the device associated with the user, a first prompt for the unique identifier, receiving, from the device and in response to the first prompt, an indication of a first identifier generated by the user, transmitting, to the device, an indication that the first identifier may be not unique based at least in part on a comparison of the first identifier with a plurality of identifiers stored in a database of the system, wherein the indication that the first identifier may be not unique comprises a second prompt for the unique identifier, and receiving, from the device and in response to the second prompt, a second identifier generated by the user, the second identifier being different from the first identifier, wherein the unique identifier embedded into the message comprises the second identifier based at least in part on the second identifier being unique among the plurality of identifiers stored in a database of the system.

Some examples of the method, apparatuses, and non-transitory computer-readable medium described herein may further include operations, features, means, or instructions for embedding an additional identifier associated with the organization into the unique identifier, wherein the message comprises the unique identifier with the embedded additional identifier.

Some examples of the method, apparatuses, and non-transitory computer-readable medium described herein may further include operations, features, means, or instructions for receiving, at the system, a second unique identifier generated by the user and provided via the device, the second unique identifier being different than the unique identifier and associating the second unique identifier with at least one account of the one or more accounts.

Some examples of the method, apparatuses, and non-transitory computer-readable medium described herein may further include operations, features, means, or instructions for generating, by the system and as part of the communication session, one or more additional messages associated with the one or more accounts after transmitting the message and transmitting the one or more additional messages to the device associated with the user, wherein the one or more additional messages exclude the unique identifier.

Some examples of the method, apparatuses, and non-transitory computer-readable medium described herein may further include operations, features, means, or instructions for providing, as part of an outbound call associated with the communication session, an indication that the user may have requested that the message comprising the unique identifier be provided by a representative of the organization, wherein the communication session comprises communications between the representative and the user, and wherein the message may be transmitted in response to the provided indication.

Some examples of the method, apparatuses, and non-transitory computer-readable medium described herein may further include operations, features, means, or instructions for determining that a threshold duration after identifying the unique identifier may have been satisfied and transmitting, to the device associated with the user, a request message comprising an indication to modify the unique identifier.

Some examples of the method, apparatuses, and non-transitory computer-readable medium described herein may further include operations, features, means, or instructions for configuring the threshold duration of based at least in part on an input from the user.

In some examples of the method, apparatuses, and non-transitory computer-readable medium described herein, the message comprises a multimedia messaging service (MMS) message, a short message/messaging service (SMS) message, push notification, or any combination thereof.

In some examples of the method, apparatuses, and non-transitory computer-readable medium described herein, the unique identifier comprises a phrase, a code, a pictogram, an image, an audio message recorded by the user, or any combination thereof.

A method is described. The method may include generating, by a system managed by an organization, a unique identifier associated with a user, the user having one or more accounts associated with the organization, wherein the unique identifier is automatically generated in response to a request received at the system from a device associated with the user, establishing a communication session between the organization and the user, generating, by the system and as part of the communication session, a message associated with the one or more accounts provided by the organization, embedding the unique identifier into the message, and transmitting, as part of the communication session, the message to the device associated with the user.

An apparatus is described. The apparatus may include a processor, memory coupled with the processor, and instructions stored in the memory. The instructions may be executable by the processor to cause the apparatus to generate, by a system managed by an organization, a unique identifier associated with a user, the user having one or more accounts associated with the organization, wherein the unique identifier is automatically generated in response to a request received at the system from a device associated with the user, establish a communication session between the organization and the user, generate, by the system and as part of the communication session, a message associated with the one or more accounts provided by the organization, embed the unique identifier into the message, and transmit, as part of the communication session, the message to the device associated with the user.

Another apparatus is described. The apparatus may include means for generating, by a system managed by an organization, a unique identifier associated with a user, the user having one or more accounts associated with the organization, wherein the unique identifier is automatically generated in response to a request received at the system from a device associated with the user, means for establishing a communication session between the organization and the user, means for generating, by the system and as part of the communication session, a message associated with the one or more accounts provided by the organization, means for embedding the unique identifier into the message, and means for transmitting, as part of the communication session, the message to the device associated with the user.

A non-transitory computer-readable medium storing code is described. The code may include instructions executable by a processor to generate, by a system managed by an organization, a unique identifier associated with a user, the user having one or more accounts associated with the organization, wherein the unique identifier is automatically generated in response to a request received at the system from a device associated with the user, establish a communication session between the organization and the user, generate, by the system and as part of the communication session, a message associated with the one or more accounts provided by the organization, embed the unique identifier into the message, and transmit, as part of the communication session, the message to the device associated with the user.

In some examples of the method, apparatuses, and non-transitory computer-readable medium described herein, generating the unique identifier may include operations, features, means, or instructions for randomly generating the unique identifier such that the unique identifier may be different from a plurality of other identifiers stored in a database of the system.

In some examples of the method, apparatuses, and non-transitory computer-readable medium described herein, generating the unique identifier may include operations, features, means, or instructions for generating a plurality of unique identifiers that may be each different from a plurality of other identifiers stored in a database of the system, the method further comprising, transmitting, to the device, a first message including an indication of the plurality of unique identifiers, and receiving, from the device, a second message indicating a selection of a first unique identifier from the plurality of unique identifiers, wherein the unique identifier embedded into the message comprises the first unique identifier based at least in part on receiving the second message indicating the selection.

Some examples of the method, apparatuses, and non-transitory computer-readable medium described herein may further include operations, features, means, or instructions for transmitting, to the device, a first message including an indication of the unique identifier generated by the system and receiving, from the device, a second message indicating that the unique identifier may be accepted by the user, wherein the unique identifier may be embedded into the message based at least in part on receiving the second message indicating that the unique identifier may be accepted by the user.

Some examples of the method, apparatuses, and non-transitory computer-readable medium described herein may further include operations, features, means, or instructions for transmitting, to the device, a first message including an indication of a first unique identifier generated by the system, the first unique identifier being unique among a plurality of other identifiers stored in a database of the system, receiving, from the device, a second message indicating that the unique identifier may be not accepted by the user, transmitting, to the device and in response to the second message, a third message including an indication of a second unique identifier generated by the system, the second unique identifier being different from the first unique identifier and being unique among the plurality of other identifiers stored in the database of the system, and receiving, from the device, a fourth message indicating that the second unique identifier may be accepted by the user, wherein the unique identifier embedded into the message comprises the second unique identifier based at least in part on the fourth message indicating that the second unique identifier may be accepted by the user.

Some examples of the method, apparatuses, and non-transitory computer-readable medium described herein may further include operations, features, means, or instructions for receiving the request from the device based at least in part on one or more failed attempts by the user to generate the unique identifier.

Some examples of the method, apparatuses, and non-transitory computer-readable medium described herein may further include operations, features, means, or instructions for receiving the request from the device based at least in part on establishing at least one of the one or more accounts by the organization.

### BRIEF DESCRIPTION OF THE DRAWINGS

FIG. 1 illustrates an example of a system that supports techniques for verifying a sender identity using a user-generated identifier in accordance with one or more aspects of the present disclosure.

FIG. 2 illustrates an example of a process flow that supports techniques for verifying a sender identity using a user-generated identifier in accordance with one or more aspects of the present disclosure.

FIG. 3 illustrates an example of a device that supports techniques for verifying a sender identity using a user-generated identifier in accordance with one or more aspects of the present disclosure.

FIG. 4 illustrates an example of a device that supports techniques for verifying a sender identity using a user-generated identifier in accordance with one or more aspects of the present disclosure.

FIG. 5 illustrates an example of a process flow that supports techniques for verifying a sender identity using a user-generated identifier in accordance with one or more aspects of the present disclosure.

FIG. 6 illustrates an example of a process flow that supports techniques for verifying a sender identity using a user-generated identifier in accordance with one or more aspects of the present disclosure.

FIG. 7 illustrates a system of that supports techniques for verifying a sender identity using a user-generated identifier in accordance with one or more aspects of the present disclosure.

FIGS. 8 and 9 illustrate flowcharts showing a method or methods that support techniques for verifying a sender identity using a user-generated identifier in accordance with one or more aspects of the present disclosure.

### DETAILED DESCRIPTION

An organization, such as a financial institution (e.g., a bank, a lender), may provide one or more accounts to a user and may transmit communications to the user, where the communications include some information associated with the accounts. For example, the organization may send alerts about account changes, prompts to update account information, alerts about possible fraudulent activity, or the like, to a device of the user, such as a smartphone or tablet. In some cases, the organization may transmit such communications using electronic communications, such as text messages or push notifications, among other examples, which may improve convenience, enable efficient and timely notifications, and increase user engagement.

Some electronic communications, however, may provide relatively fewer authentication opportunities compared with other types communications. For example, text messages may be sent from an unrecognized number and it may be difficult to verify whether a text message is from a trusted source based solely on the sender's number. Similarly, while received emails may include a relatively more detailed “from” line to review (e.g., for verifying whether the sending is legitimate or potentially fraudulent), text messages may lack such identifiers. Additionally, some electronic communications may include an identifier associated with a legitimate organization, but such identifiers may be publicly available, and therefore easily duplicated by a malicious third party, for example, when attempting to obtain private information from the user. As a result, a user may not be able to tell whether a message was sent by a legitimate source based solely on an identifier of the organization (e.g., a known and widely-available logo) included with a received message. Accordingly, the user may be at relatively greater risk of falling prey to a malicious third party impersonating the organization (e.g., using a phishing attempt (e.g., an attempt to get a user to depart with something of value, such as money or personal information, through deceptive communications)). Thus, techniques to improve the security of electronic communications are desired to enable enhanced authentication of a source (e.g., the identity of the sender) for various electronic communications.

As described herein, a user having one or more accounts with an organization may generate a unique identifier (e.g., a unique phrase, a unique image, a unique code, among other examples) for association with one or more accounts, and the organization may include the unique identifier in subsequent electronic communications to the user. For example, as part of setting up a new account, modifying an existing account, or both, the user may generate and transmit the unique identifier to the organization using a device (e.g., a smartphone, a tablet, a laptop, or the like), and the organization may associate the unique identifier with the one or more accounts of the user. Subsequently, the organization may establish a communication session with the user, such as by generating a message (e.g., text message, a push notification, an email) that includes information associated with the one or more accounts. The organization may embed the unique identifier into the message and transmit the message to the user (e.g., to the device of the user). After receiving the message, the user may verify that the message includes the unique identifier, the presence of which may enable verification that the source of the message is the organization, rather than a malicious third party. In some aspects, the unique identifier may be generated by the user and transmitted to the organization. In other examples, the unique identifier may be automatically and randomly generated by the organization, for example, based on a request received from the user. In such cases, the automatically and randomly-generated identifier may be transmitted to the user for approval, and once approved, the identifier may be used for subsequent communications between the organization and the user.

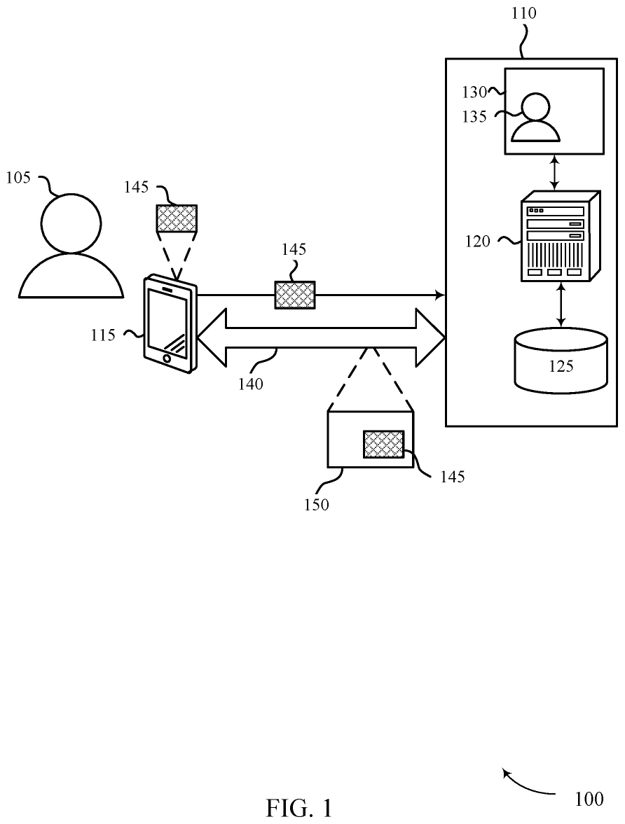

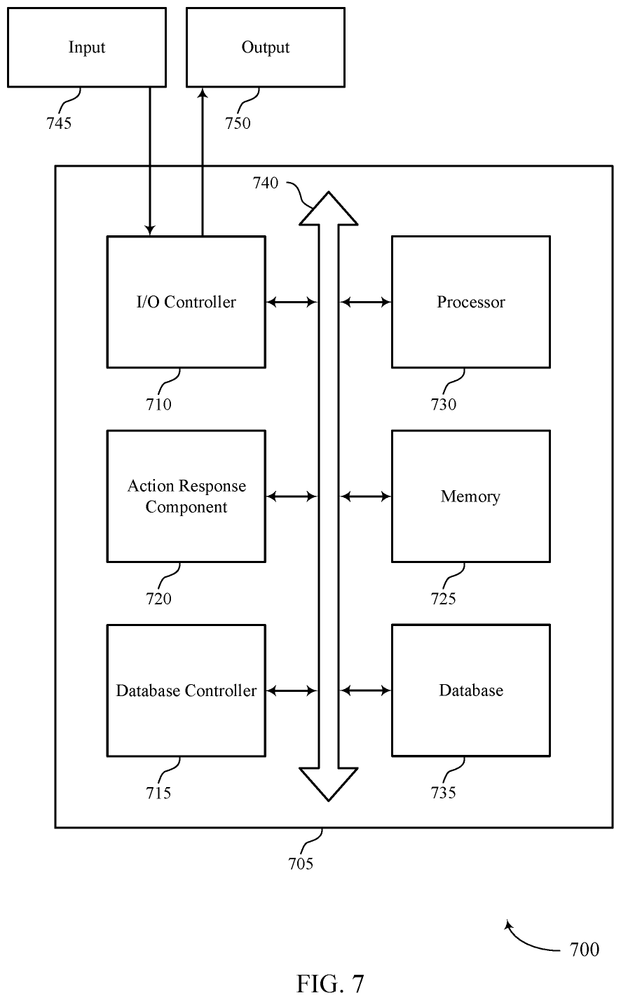

Aspects of the disclosure are initially described in the context of systems and process flows with reference to FIGS. 1 through 6. Aspects of the disclosure are further illustrated by and described with reference to systems and flowcharts that relate to techniques for verifying a sender identity using a user-generated identifier with reference to FIGS. 7, 8, and 9.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system to additionally, or alternatively, solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 1 illustrates an example of a system 100 that supports techniques for verifying a sender identity using a user-generated identifier in accordance with one or more aspects of the present disclosure. The system 100 may include one or more users 105 which may interact with one or more organizations 110 (e.g., entities, companies, banks, corporations, credit unions, lenders) using one or more devices 115 over a network, such as the Internet. Accordingly, a user 105 described herein may be associated with one or more devices 115 (e.g., a desktop computer, a laptop, a smartphone, a tablet, other computing system, or any combination thereof). Similarly, the organization 110 described herein may be associated with or may utilize one or more devices (e.g., computers, servers, databases, platforms, or the like), such as a server 120, a database 125, a communication center 130 which includes one or more representatives 135, or any combination thereof.

In some examples, the organization 110 and the one or more devices 115 may communicate using various messages and communications protocols. For instance, the organization 110 and the one or more devices 115 may communicate via a wireless communications system supporting various types of communication content such as messaging (e.g., text messaging), voice, video, packet data, broadcast, and so on. Such wireless communications systems may be capable of supporting communication with multiple users by sharing available system resources (e.g., time, frequency, and power) over one or more radio frequency spectrum bands. Examples of such multiple-access systems include fourth generation (4G) systems such as Long Term Evolution (LTE) systems, LTE-Advanced (LTE-A) systems, or LTE-A Pro systems, and fifth generation (5G) systems, which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). Additionally, or alternatively, the organization 110 and the one or more devices 115 may communicate using one or more wired communications system supporting the various types of communication content (e.g., messaging, voice, video, packet data, and so forth).

In some cases, messaging between the organization 110 and the one or more devices 115 may be supported by a core network providing user authentication, access authorization, tracking, Internet Protocol (IP) connectivity, and other access, routing, or mobility functions. The core network, for example, may be an evolved packet core (EPC) or 5G core (5GC), which may include at least one control plane entity that manages access and mobility and at least one user plane entity that routes packets or interconnects to external networks. In some aspects, user IP packets may be transferred through the user plane entity, which may provide IP address allocation as well as other functions. The user plane entity may be connected to IP services for one or more network operators. The IP services may include access to the Internet, Intranet(s), an IP Multimedia Subsystem (IMS), or a Packet-Switched Streaming Service.

The server 120 may include a framework in which to run the one or more applications associated with the one or more devices 115. For example, the server 120 may be an application server and may implement system software on which the applications may run. More generally, the server 120 may provide a software framework for creating and running applications. As such, the server 120 may support administrative functions for creating, modifying, or otherwise managing various applications. For example, an administrative user or software developer may create and customize an application using various software or components of the server 120 (e.g., an application builder, an application programming interface (API), or other application tools). The server 120 may support building applications or pages that may be rendered on a number of different user interface types at the devices 115 (e.g., including different types and versions of devices 115). In some cases, the server 120 may perform data processing, and the server 120 may be an example of a cloud device or may be located at a data center. The server 120 may support serving dynamic content and transferring applications or application data from one device 115 to another. In some cases, the server 120 may further provide for hosting business logic applications and processes using various protocols.

In some cases, the server 120 may be part of a client-server system, a mobile device system, an electronic banking system, a mobile network system, or the like, which may support techniques to enable a user 105 to verify the identity of the organization 110 using a user-generate unique identifier 145. For example, as part of a communication session 140 between the organization 110 and the user 105, the organization 110 may include the user-generated unique identifier 145 within one or more messages 150 of the communication session 140.

The communication session 140 may include the signaling of the one or more messages 150 between the organization 110 and the one or more devices 115, where such messages may include text messages, push notifications, email, or the like. Text messages may refer to short messaging service (SMS) or multimedia messaging service (MMS), which may respectively relate to communications protocols for sending and receiving messages (e.g., via cellular networks). For example, SMS may sometimes be associated with a threshold quantity of characters (e.g., associated with a threshold quantity of bits) included in a message and may enable the inclusion of a link (e.g., a uniform resource locator (URL)) within a message. MMS may not have such character thresholds (or may have relatively greater character limits and/or threshold quantities of bits) and may further enable the inclusion of media files (e.g., pictures, audio files, video files, gifs, or the like) within a message. Push notifications may refer to relatively short messages sent to a user's one or more devices (e.g., the one or more devices 115) from a backend server to a user interface, for example, via an application (e.g., a mobile application, a desktop application). Push notification may appear on the interface of the user's one or more devices 115 even when an associated application is not in use. In other examples, the messages of the communication session 140 may include an email or other type of electronic or digital message not explicitly described herein.

In some examples, the communication session 140 may additionally or alternatively include one or more voice communications between the organization 110 and the one or more devices 115. Such voice communications may include, for example, recorded voice messages, IP telephony (e.g., voice over IP (VOIP) communications) for the delivery of voice communications and multimedia sessions over an IP network (e.g., the Internet), or both. The communication session 140 may include an outbound call from a representative of the organization 110 to the user 105 (e.g., to the one or more devices 115) or an inbound call from the one or more devices 115 to a representative of the organization 110.

As described herein, a user 105 having one or more accounts with the organization 110 may generate a unique identifier 145 and provide, using the one or more devices 115, the unique identifier 145 to the organization 110. For example, the user 105 may use an application associated with the organization 110, such as a banking application or online portal, among other examples, to create and input a unique identifier 145 to the application via the one or more devices 115. The application may transmit the unique identifier to the organization 110, and the organization 110 may store the unique identifier 145, for example in a database 125. The organization 110 may embed the unique identifier 145 in future communications between the organization 110 and the user 105 (e.g., the one or more devices 115 of the user 105). In some cases, the organization 110 may, as part of communications between the organization 110 and the user 105, transmit the unique identifier 145 to a different device 115 than the device 115 used to provide (e.g., generate and transmit) the unique identifier 145. For example, the user 105 may use a first device 115, such as a laptop, to provide the unique identifier 145 to the organization 110, and the organization 110 may transmit communications, including the unique identifier 145, to a second device 115, such as a mobile phone (e.g., smartphone) of the user 105. That is, the user 105 may receive one or more messages 150 including the unique identifier 145 from the organization 110 via any device 115 (e.g., one or more devices 115 that are registered with the organization 110).

The unique identifier 145 may include a phrase, a passcode, a logo, pictogram (e.g., an emoji), an image (e.g., a portable network graphic (PNG) image, a joint photographic experts group (JPEG) image, or the like), letters, numerals, special characters, an audio file (e.g., an audio message recorded by the user 105, such as the user's own voice or another audio recording), among other examples, or any combination thereof. In some cases, the user 105 may input the unique identifier 145 to the one or more devices 115 as part of setting up the one or more accounts of the user 105. Additionally, or alternatively, the user 105 may generate or update (or both) a unique identifier 145 as part of improving security of an account. For instance, the user 105 may periodically update the unique identifier 145. In some aspects, a type of the message that includes the unique identifier 145 may be based on the unique identifier. For example, when the unique identifier 145 is an image, the message may be an example of an MMS text message, and when the unique identifier 145 is a text string (e.g., a phrase, a code), the message may be an example of an SMS text message or push notification. In some aspects, the unique identifier 145 may be referred to as a “know your sender” identifier or some other terminology.

In some cases, the user 105 may generate multiple unique identifiers 145. For example, the user 105 may generate a unique identifier 145 for each of two or more accounts associated with the user 105. Additionally, the user 105 may generate multiple types of unique identifiers 145 (e.g., passcodes, phrases, images, audio files), with each type of unique identifier 145 corresponding to or configured for a type of communication, such as text communication, voice communication, relatively high sensitivity communication, relatively low sensitivity communication, or the like.

In some examples, the organization 110 may verify that the user-generated unique identifier 145 is unique (e.g., unique among identifiers of other users 105 associated with the organization 110, such as identifiers stored in the database 125), and the organization 110 may store the unique identifier 145 in the database 125. Such verification may be based on a comparison of the user-generated unique identifier 145 with the other identifiers stored in the database 125. Based on the comparison, the organization 110 may indicate to the user 105 (e.g., via the one or more devices 115) that the user-generated identifier 145 is unique. Alternatively, in the case where the user-generated identifier 145 is not unique based on the comparison, the organization 110 may request that the user 105 (e.g., via the one or more devices 115) generate an additional, different user-generated identifier 145. Such a process may occur until the user-generated identifier 145 is determined to be unique and associated with one or more accounts of the user 105 by the organization 110. In some aspects, the user-generated identifier 145 may be used by the organization 110 for communications associated with a particular account (e.g., a savings account, a checking account, a credit card account), a particular line of business (e.g., deposit accounts, mortgage accounts, investment accounts), or for all communications (e.g., at a total relationship level), or any combination thereof.

Subsequently, the organization 110 may initiate the communication session 140 between the organization 110 and the user 105. For example, the organization 110 may generate and transmit a message 150, such as a text message (e.g., an SMS message, an MMS message, a push notification, or the like) to the one or more devices 115 of the user 105. To authenticate the message 150 to the user 105, the organization 110 may embed (e.g., automatically embed) the user-generated unique identifier 145 into the message 150 prior to transmitting the message 150 to the one or more devices 115. After receiving the message 150, the one or more devices 115 may display the message 150, along with the embedded unique identifier 145, to the user 105 via an interface of the one or more devices 115, which may allow the user 105 to verify the identity of the source of the message 150.

In some examples, the communication session 140 may be an example of or may include an audio message to the user 105 from organization 110. For example, the organization 110 may communicate sensitive information, such as account information (e.g., login codes), account warnings or notifications (e.g., transaction validation warnings), or the like, using a pre-recorded voice message (e.g., to ask the user 105 to call back, to provide the user 105 with a reminder or other information) to the one or more devices 115 of the user 105. In such cases, the pre-recorded voice message may include (e.g., automatically include) the unique identifier 145. For example, the user 105 may generate a unique identifier 145 that includes an audio message recorded by the user 105, and the pre-recorded voice message may play the audio message (e.g., at the beginning of the call, at the end of the call), which may allow the user 105 to verify the identity or source of the pre-recorded voice message (e.g., to determine that the pre-recorded voice message is authentic). In some aspects, respective unique identifiers 145 may be generated for different types of communications. For example, a unique identifier 145 associated with pre-recorded voice messages may be different than another unique identifier 145 associated with other messages, such as text messages, push notifications, or email.

Additionally, or alternatively, the communication session 140 may be an example of a live telephone call between the organization 110 and the user 105. For example, a representative 135 of the organization 110 (e.g., a customer service representative) may initiate the telephone call as part of, for example, an outbound call associated with an account of the user 105, a call-back associated with a service request by the customer, or the like. In such cases, the representative 135 may concurrently, and as part of the communication session 140, send the unique identifier 145 to the user's device 115, which may allow the user 105 to verify that the caller is from the organization 110.

For example, as part of the telephone call between the representative 135 and the user 105, the user 105 may request verification of the identity of the representative 135. In such cases, the representative 135 may cause the system 100 (e.g., using the server 120 or other device included in the communication center 130) generate a message (e.g., a text message), which includes the unique identifier 145, and may cause the system 100 to transmit the message to the one or more devices 115. Additionally, or alternatively, the representative 135 may cause the system 100 to transmit the message which includes the unique identifier 145 to the one or more devices 115 without a request from the user 105 during the telephone call. For example, as part of setting up the unique identifier 145, the user 105 may request to automatically receive the unique identifier 145 for future telephone calls from the organization 110. Accordingly, the representative 135 may cause the system 100 to generate and transmit a message which includes the unique identifier 145 as part of initiating the telephone call and based on the request from the user 105.

Including (e.g., prominently displaying) the user-generated unique identifier 145 in a message 150 transmitted to the one or more devices 115 from the organization 110 may enable enhanced security for the one or more messages 150 received from the organization 110. As an example, the user 105 may verify the identity of the sender of the one or more messages 150 based on the presence of the user-generated unique identifier. Accordingly, the user 105 may better detect fraudulent messages, such as phishing attempts or other cyber fraud attempts, which may improve security and reliability of sensitive information associated with the user 105. Moreover, the user 105 may perform further actions after receiving the secure messages with increased confidence that the sender is verified, which may enable the user 105 to take timely action (e.g., related to one or more accounts) in accordance with the content of a received message 150.

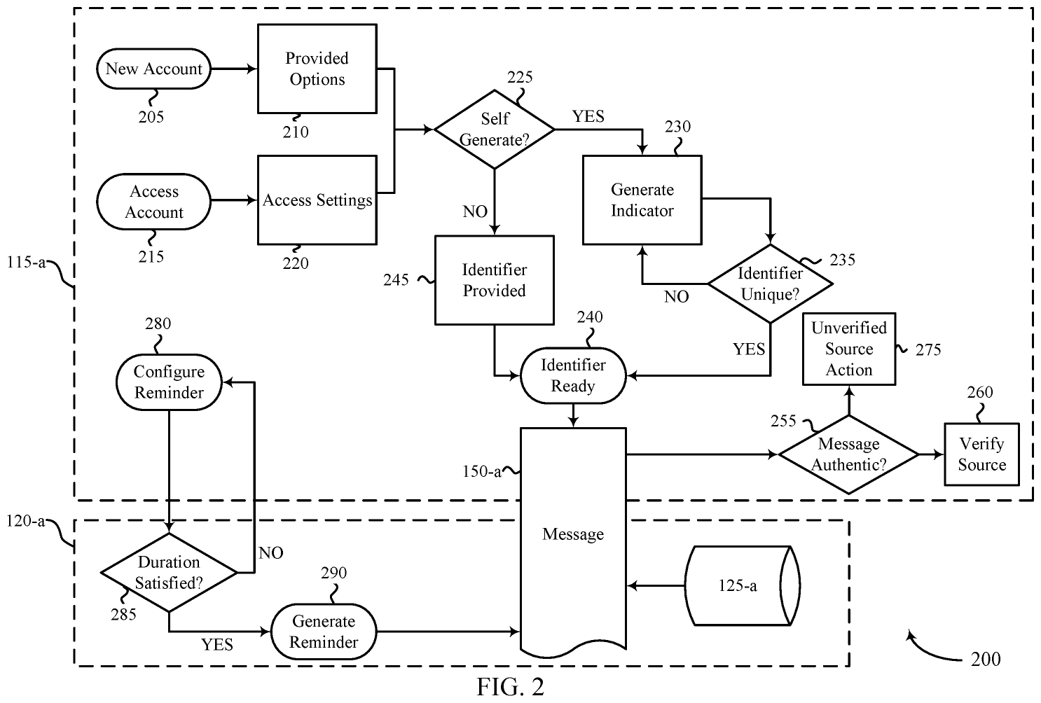

FIG. 2 illustrates an example of a process flow 200 that supports techniques for verifying a sender identity using a user-generated identifier in accordance with one or more aspects of the present disclosure. The process flow 200 or aspects thereof may be implemented by a device 115-a associated with a user (e.g., a user 105) and by a server 120-a associated with an organization (e.g., an organization 110), which may each be examples of the corresponding entities as described with reference to FIG. 1. For example, the device 115-a may be an example of the one or more devices 115 described with reference to FIG. 1. Additionally, the server 120-a may be associated with a system managed by an organization and may further support the operation of one or more applications associated with the organization, and the system may enable the communication of one or more messages between the organization and the user. In the following description of the process flow 200, the operations may be performed in a different order than the order shown. For example, specific operations may be left out of the process flow 200, or other operations may be added to process flow 200.

The process flow 200 may illustrate methods to generate, manage, and communicate a user-generated unique identifier, such as the unique identifier 145 as described with reference to FIG. 1. In some cases, the server 120-a may be in communication with the device 115-a using one or more communication channels, such as via an online portal, a website or application (e.g., a client-server application), a communication session in which the server 120-a communicates messages (e.g., text messages, telephone calls) with the device 115-a, or both.

By way of example, as part of setting up an account with the organization at 205 (e.g., a checking account, savings account, mortgage account, or the like), the server 120-a may, at 210, provide the device 115-a with one or more options to generate a unique identifier for the account. Additionally, or alternatively, the user may, using the device 115-a at 215, access a profile of one or more existing accounts (e.g., login to an online portal, which may display aspects of the profile on the device 115-a). The user may, at 220, access and modify one or more account settings associated with the profile, and may determine to generate a unique identifier for an account of the one or more accounts, or to update one or more existing unique identifiers associated with the one or more accounts.

In some examples, the profile may support (e.g., may allow the user to configure one or more parameters using the device 115-a to cause the server 120-a to perform operations which allow) associating a same unique identifier to multiple accounts of the one or more accounts. Additionally, or alternatively, the profile may support associating a different unique identifier for each of the one or more accounts. Further, the profile may support associating multiple unique identifiers with a same account. For example, the profile may support associating a first unique identifier associated with a first security level with an account, and may support associating a second unique identifier associated with a second, different security level with the account. In some cases, the profile may support configuring the first security level, the second security, or both, for example, by allowing the user to associate particular types of communications with a particular security level. For instance, communications associated with possible fraud may be configured with a relatively highest security level, whereas communications confirming a deposit to an account may be configured with a relatively lower security level.

At 225, the device 115-a may determine, based on an input from the user, whether to generate a unique identifier, or whether to request a unique identifier from the server 120-a. If the device 115-a determines to generate the unique identifier, the user may, at 230, input an identifier (e.g., may upload an image, may input a passcode, may input a code, may input a phrase, may upload an audio recording) to the device 115-a (e.g., via an application), and the device 115-a may transmit the identifier to the server 120-a. In some examples, such as if the user has determined to update an existing identifier, the user may input an identifier different than the existing identifier.

In some cases, the server 120-a may, at 235, compare the received identifier with a database 125-a of identifiers (e.g., identifiers associated with other users of the organization) to determine whether the identifier is unique. If the server 120-a determines that the identifier is unique, the server 120-a may, at 240, associate the unique identifier with one or more accounts of the user (e.g., in accordance with options provided at 210, in accordance with the settings accessed at 220). Alternatively, if the server 120-a determines that the identifier is not unique, the server 120-a may transmit an indication to the device 115-a, and the user may provide one or more additional identifiers (e.g., until the server 120-a determines that a provided identifier is unique).

In some examples, at 225, the user may determine to request, using the device 115-a, a unique identifier from the server 120-a. In such cases, the server 120-a may, at 245, automatically generate the unique identifier (e.g., unique among the identifiers of the database 125). For example, the server 120-a may randomly generate the unique identifier, and may ensure that the generated unique identifier is unique among identifiers of the database 125 (e.g., by randomly generating and checking the generated identifier against the database 125, or by other means). In some cases, the device 115-a may request the unique identifier from the server 120-a in response to one or more failed attempts by the user to generate the unique identifier. That is, if the user is unable or unwilling to generate their own unique identifier using the device 115-a after any number of attempts (e.g., one or more attempts at a user-generated identifier were not complex enough to be unique), the user may request that the system automatically generate (e.g., randomly generate) the unique identifier. At 245, the system may provide the generated identifier to the user (e.g., for approval). In cases where they server 120-a automatically and randomly generates the unique identifier, the system may use various techniques for generating the identifier, such as randomly generating one or more alphanumeric strings, randomly generating one or more images, randomly generating one or more phrases, or any combination thereof, among other examples.

In some examples, the server 120-a may determine (e.g., via input to the device 115-a) whether the user accepts the generated unique identifier. If the user accepts the unique identifier, the server 120-a may, at 240, associate the unique identifier with the one or more accounts. In some aspects, the unique identifier may be associated with a single account, or may be associated with one or more accounts associated with a particular business line (e.g., deposit accounts), or may be associated with a variety of accounts provided to the user by the organization (e.g., across various lines of business, particular accounts in respective lines of business), among other examples. Alternatively, if the user does not accept the unique identifier, the server 120-a may generate one or more additional unique identifiers (e.g., until the user accepts a generated unique identifier) and associate the accepted unique identifier with the one or more accounts. The user, via the device 115-a, may request any number of unique identifiers be generated until a unique identifier is selected and indicated to the server 120-a.

In some examples, the device 115-a may modify an identifier generated by the server 120-a, such as by adding additional characters, images, or both (e.g., provided by user input to the device 115-a) to the generated identifier. Additionally, or alternatively, the server 120-a may generate multiple unique identifiers, and may transmit the multiple unique identifiers to the device 115-a. The user may select one of the multiple unique identifiers (e.g., via input to the device 115-a), and the device 115-a may transmit the selection to the server 120-a.

To further enhance the security provided by the unique identifier, the server 120-a may embed an image or code, such as image associated with the organization (e.g., a logo, an emblem, or the like), a phrase or code associated with the organization, or both, into the unique identifier. For example, if the unique identifier includes an image, the server 120-a may overlay an image associated with the organization over the image of the unique identifier. Additionally, or alternatively, if the unique identifier includes an alphanumeric passcode (e.g., a text string), the server 120-a may convert the passcode into an image, and may overlay the image associated with the organization over the converted image. Embedding the image or code in the unique identifier may allow for enhanced identification (e.g., by the user) of the unique identifier, reduce the likelihood of a malevolent third party from impersonating the organization (e.g., reduce the likelihood of phishing, spear-phishing, smishing, vishing, or other similar actions), or both.

In some examples, the server 120-a may update a security score associated with the user in response to setting up the one or more unique identifiers. For example, the server 120-a may award a badge or certification to the user, which may indicate that the user has enabled unique identifier verification. Such rewards may incentivize and increase the use of the one or more unique identifiers across various accounts of the user, thereby enhancing security for messages sent by the organization.

Subsequent to associating the unique identifier with the one or more accounts, the server 120-a may embed the unique identifier within a message 150-a to the user (e.g., to the device 115-a) associated with the one or more accounts. For example, the server 120-a may generate a message 150-a, such as a text message, email or any other digital or electronic communication, to inform the user of a change of one or more account settings associated with the one or more accounts. The server 120-a may embed the unique identifier, along with one or more identifier associated with the organization (e.g., a logo, phrase, or the like) into the message 150-a, and may transmit the message 150-a to the device 115-a.

Upon the device 115-a receiving the message 150-a, the user may, at 255, determine whether the message 150-a is authentic (e.g., whether the source of the message 150-a is the organization, or whether the message 150-a is fraudulent). If the message 150-a includes the unique identifier, the user may, at 260, verify that the organization sent the message 150-a. Alternatively, if the message 150-a does not include the unique identifier, the user may, at 275, determine that the message 150-a may be fraudulent. Accordingly, the user may perform one or more actions, such as ignoring the message 150-a, deleting the message 150-a, reporting the message 150-a (e.g., to the organization), or any combination thereof.

In some examples, the device 115-a may configure one or more parameters associated with providing a reminder to the user to update the unique identifier. For example, at 280, the device 115-a may configure or enable the configuration of a duration of time between reminders (e.g., configure whether to receive reminders weekly, monthly, quarterly, annually). Accordingly, after determining that the duration has elapsed at 285, the server 120-a may, at 290, generate a message 150-a which includes an indication that the duration has elapsed, and may transmit the message 150-a to the device 115-a (e.g., as a reminder to the user). In some examples, the server 120-a may embed the unique identifier into the reminder message 150-a. In some cases, the user may reset or update the unique identifier used for messaging with some periodicity to further enhance the security benefits of using such an identifier for messaging.

To enhance security of the unique identifier, the server 120-a may not display the unique identifier within the profile. Instead, the profile may support a request by the device 115-a to transmit a message 150-a which includes one or more unique identifiers associated with the one or more accounts. For example, the profile may include a forgotten identifier feature, which may allow the user, using the device 115-a, to request a reminder of the one or more unique identifiers. In response to the request, the server 120-a may embed the one or more unique identifiers into a message 150-a, and may transmit the message 150-a to the device 115-a to provide the user with a reminder of a previously-generated unique identifier.

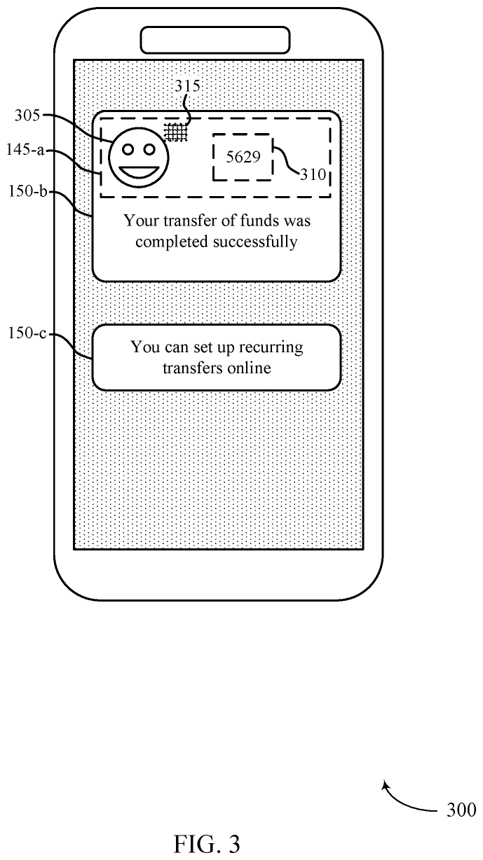

FIG. 3 illustrates an example of a device 300 that supports techniques for verifying a sender identity using a user-generated identifier in accordance with one or more aspects of the present disclosure. The device 300 may be an example of a device 115 or a device 115-a described with reference to FIGS. 1 and 2. For example, the device 300 may be a smartphone, a tablet, a desktop computer, or other computing system. In some examples, the device 300 may provide an interface by which a user (e.g., a user 105) may interact with the device 300 to manage one or more unique identifiers associated with one or more accounts of the user.

The device 300 may illustrate one or more messages 150 received from an organization (e.g., from a server 120 managed by the organization 110, from a system managed by the organization), which may include one or more unique identifiers 145 (e.g., a unique identifier 145-a). In some cases, the device 300 may be configured to receive messages, such as text messages (e.g., SMS messages, MMS messages), telephone calls, or both from the organization as part of a communication session between the organization and the user. The device 300 may be further configured to display the messages 150, along with the unique identifiers 145, to the user.

For example, the message 150-b may be an example of a message transmitted to the device 300, which may include transaction information associated with an account of the user (e.g., information indicating that a transaction was successful, information asking the user if a charge is authorized, or the like). Prior to transmitting the message 150-b, the organization may embed the unique identifier 145-a into the message 150-b. After receiving the message 150-b, the device 300 may display the message 150-b, along with the unique identifier 145-a, to the user. Accordingly, the user may determine that the unique identifier 145-a is correct (e.g., verify that the unique identifier 145-a is the same as the user-generated identifier associated with the account), and accordingly verify the authenticity of the communication session (e.g., verify the source of the message 150-b). In some aspects, the inclusion of the unique identifier 145-a in the first message (e.g., message 150-b) of a series of messages may be based on whether the first message requests some information from the user (e.g., requires interaction by the user), whereas following messages in the series may omit the unique identifier 145-a.

In some examples, the organization may transmit multiple messages 150 as part of a same communication session. For example, the organization may transmit another message 150-c, which may include additional information associated with the communication session. Because the user may verify authenticity of the communication session using the unique identifier 145-a within the message 150-b, the organization may refrain from embedding (e.g., not embed) the unique identifier 145-a in subsequent messages of the same communication session, such as the message 150-c.

A unique identifier 145-a may include a phrase (e.g., a string of characters, numerals, or other symbol), a passcode, a pictogram (e.g., an emoji), an image, an audio message recorded by the user, or any combination thereof. By way of example, the unique identifier 145-a illustrated in FIG. 3 may include a pictogram 305. Additionally, or alternatively, the unique identifier 145-a may include a code 310 (e.g., a passcode, a string of numerals). In some examples, the unique identifier 145-a may optionally include an additional identifier 315 associated with the organization, such as a logo of the organization. The additional identifier 315 may be embedded in the unique identifier 145-a.

In some cases, the user may generate the unique identifier 145-a as part of setting up the account, such as by inputting the unique identifier to the device 300, which may provide the input unique identifier 145-a to the organization (e.g., via an application managed by the organization). Additionally, or alternatively, the user may generate the unique identifier 145-a as part of updating the account (e.g., as part of associating a new unique identifier 145 with the account, updating a unique identifier 145-a associated with the account, or both). In some examples, the organization may modify the user-generated unique identifier 145-a to include the additional identifier 315.

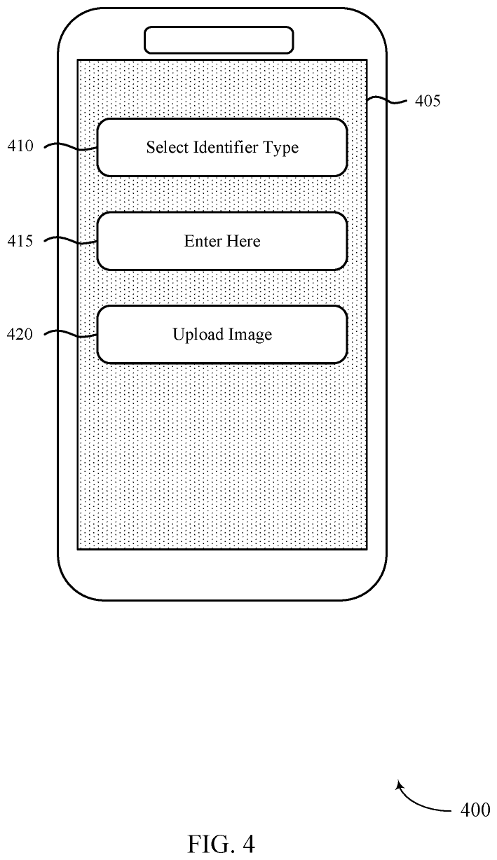

FIG. 4 illustrates an example of a device 400 that supports techniques for verifying a sender identity using a user-generated identifier in accordance with one or more aspects of the present disclosure. The device 400 may be an example of one or more devices 115 described with reference to FIG. 1 or a device 115-a described with reference to FIG. 2, or a device 300 described with reference to FIG. 3. For example, the device 400 may be a smartphone, a tablet, or other computing system. In some examples, the device 400 may provide an interface by which a user (e.g., a user 105) may interact with the device 400 to manage one or more unique identifiers associated with one or more accounts of the user.

In some examples, the device 400 may run one or more instances of an application 405 associated with an organization (e.g., provided by a system managed by the organization), such as a financial institution (e.g., a bank, a lender). The application may provide the user with various features and services related to the one or more accounts (e.g., checking accounts, savings accounts, investment accounts, retirement accounts) that are established and held with the organization. For example, the user may be provided with (e.g., the system may transmit to the device 400) one or more widgets, icons, modules, menus, prompts, text fields, or the like, to perform various actions and functions within the application 405.

The application 405 may enable the user to manage one or more unique identifiers as part of creating a new account, modifying an existing account, or both. For example, as part of creating an account, modifying the account, or both, the system managed by the organization may transmit an indication to the application 405 to display a prompt to the user to generate a unique identifier to associate with the account. In some examples, the application 405 may provide a menu 410, which may allow the user to input a selected type for the unique identifier, such as a phrase, a passcode, a pictogram, an image, an audio message recorded by the user, or any combination thereof.

In response to user input to the menu 410, the application 405 may display one or more additional prompts to the user. For example, if the user selected a text-based type for the unique identifier (e.g., a phrase, a passcode, a pictogram, or any string of characters), the application 405 may display a text field 415. The user may generate an identifier and input the identifier to the text field 415. Additionally, or alternatively, if the user selected an image-based type for the unique identifier, the application 405 may display an image field 420, which may allow the user to input (e.g., upload) an image file, such as a PNG file, a JPEG file, or the like, as the identifier.

Upon receiving the input identifier, the application 405 may, via the device 400, transmit the identifier to the system. Accordingly, the system may verify whether the identifier is unique (e.g., unique among a database of identifiers associated with other users). If the system verifies that the identifier is unique, the system may associate the identifier with the account, and may embed the unique identifier in subsequent messages associated with the account to the user. Alternatively, if the system does not verify that the identifier is unique (e.g., if the system identifies a same or similar identifier within the database), the system may transmit a message to the device 400 indicating that the identifier is not unique. Accordingly, the application 405 may display an additional prompt to the user to generate a second identifier, which the application 405 may transmit to the system. The system may determine whether the second identifier is unique, and so on, until a unique identifier is obtained.

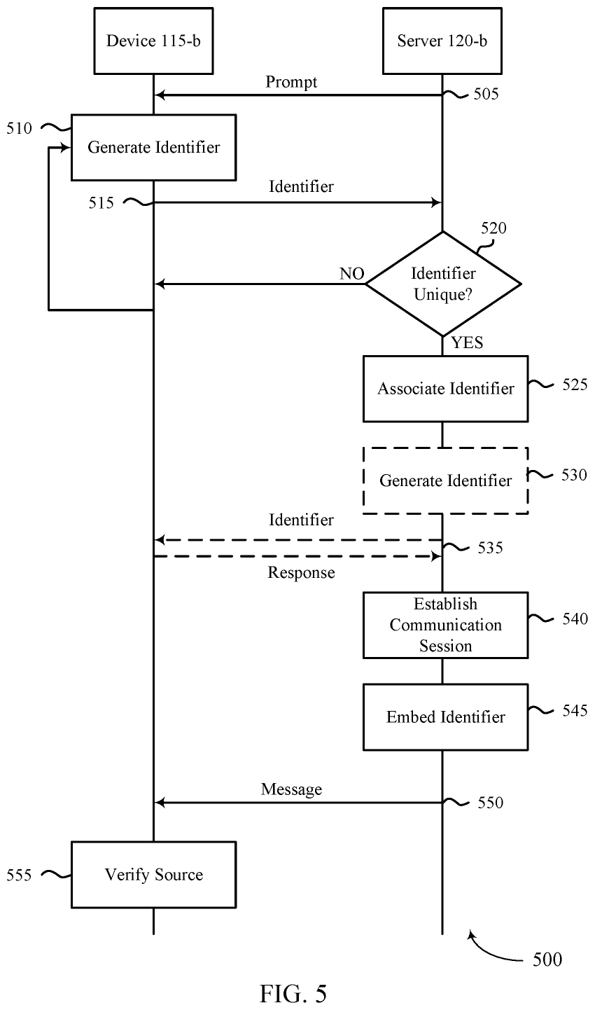

FIG. 5 illustrates an example of a process flow 500 that supports techniques for verifying a sender identity using a user-generated identifier in accordance with one or more aspects of the present disclosure. The process flow 500 or aspects thereof may be implemented by a device 115-b associated with a user (e.g., a user 105) and by a server 120-b associated with an organization (e.g., an organization 110), which may each be examples of the corresponding entities as described with reference to FIGS. 1 through 4. For example, the device 115-b may be an example of one or more devices 115, a device 115-a, a device 300, or a device 400, as described with reference to FIGS. 1 through 4. The server 120-c may be an example of a server 120 or a server 120-a described with reference to FIGS. 1 and 2. The server 120-b, in some examples, may provide functionality for, or support aspects of, a system managed by an organization. In the following description of the process flow 500, the operations may be performed in a different order than the order shown. For example, specific operations may also be left out of the process flow 500, or other operations may be added to process flow 500.

The process flow 500 may illustrate a method to associate a user-generated unique identifier with one or more accounts of the user, and include the unique identifier in communications from the server 120-b to the device 115-b. In some examples, the user may generate the unique identifier as part of setting up a new account. Additionally, or alternatively, the user may update or associate an additional unique identifier with an existing account.

At 505, the server 120-b may transmit a prompt for a unique identifier to the device 115-b. For example, as part of setting up a new account, modifying an existing account, or both, the user may determine to generate and associate a unique identifier of the account. Accordingly, the user may, using the device 115-b, access an application managed by the server 120-b, such as an application 405 as described with reference to FIG. 4. In response, the server 120-b may transmit or provide the prompt to the device 115-b

Accordingly, at 510, the user may generate an identifier and input the identifier to the device 115-b (e.g., input in response to the prompt). For example, the user may generate a phrase, a passcode, a pictogram, an image, an audio message recorded by the user, or any combination thereof, and may input the generated identifier to the device 115-b. The device 115-b may, at 515, transmit the identifier to the server 120-b, and the server 120-b may, at 520, determine whether the identifier is unique.

For example, the server 120-b may compare the received identifier with one or more identifiers stored in a database (e.g., a database 125) and associated with other users (e.g., accounts of other users), and may determine whether the received identifier is the same or similar to an identifier of the one or more identifiers. If the server 120-b determines that the received identifier is not unique, the server 120-b may transmit an indication (e.g., an error message) to the device 115-b, along with a prompt to generate and input an additional identifier. Accordingly, the process flow 500 may return to 510.

Alternatively, the server 120-b determines that the received identifier is unique, the server 120-b may, at 525, associate the identifier with the user (e.g., one or more accounts of the user). For example, the server 120-b may store the unique identifier within a profile of the user. In some examples, as part of associating the identifier with the user, the server 120-b may modify the received identifier. For example, the server 120-b may embed an additional identifier, such as an image associated with organization (e.g., a logo of the organization), a phrase associated with the organization, or both, within the received identifier. In some cases, to embed the additional identifier, the server 120-b may overlay the additional identifier onto the received identifier.

In some cases, the user may request that the server 120-b generate a unique identifier for the user (e.g., rather than the user generating the unique identifier). For example, as part of setting up or modifying the account, the user may cause (e.g., via the application) the device 115-b to transmit an indication to the server 120-b to generate an identifier. Accordingly, at 530, the server 120-b may generate a unique identifier and associate the unique identifier with the user.

In some cases, the server 120-b may determine whether the user approves the generated identifier. For example, at 535, the server 120-b may transmit the generated identifier to the device 115-b. If the user approves the identifier, the user may cause (e.g., via the application) the device 115-b to transmit an acknowledgment to the server 120-b, and the server 120-b may associate the identifier with the account. Alternatively, if the user does not approve the identifier, the user may cause the device 115-b to transmit a request to the server 120-b for a second identifier. Accordingly, the process flow 500 may return to 530.

The server 120-b may include the unique identifier associated with an account in subsequent communication associate with the account to the device 115-b. For example, at 540, the server 120-b may establish a communication session between the device 115-b and the server 120-b. As part of the communication session, the server 120-b may generate a message associated with the account (e.g., a message which includes account information). In some examples, the message may include an MMS message, an SMS message, a push notification, or any combination thereof.

At 545, the server 120-b may embed the unique identifier in the message. For example, the server 120-b may attach the unique identifier to the message, or otherwise modify the message to display the unique identifier. Accordingly, at 550 the server 120-b may transmit the message, including the embedded identifier, to the device 115-b. After receiving the message, the device 115-b may, at 555 support verifying the source of the message (e.g., the sender of the message) by displaying the message and embedded identifier to the user. By viewing the embedded identifier, the user may verify the source of the message, and thus increase security of communications between the organization and the user.

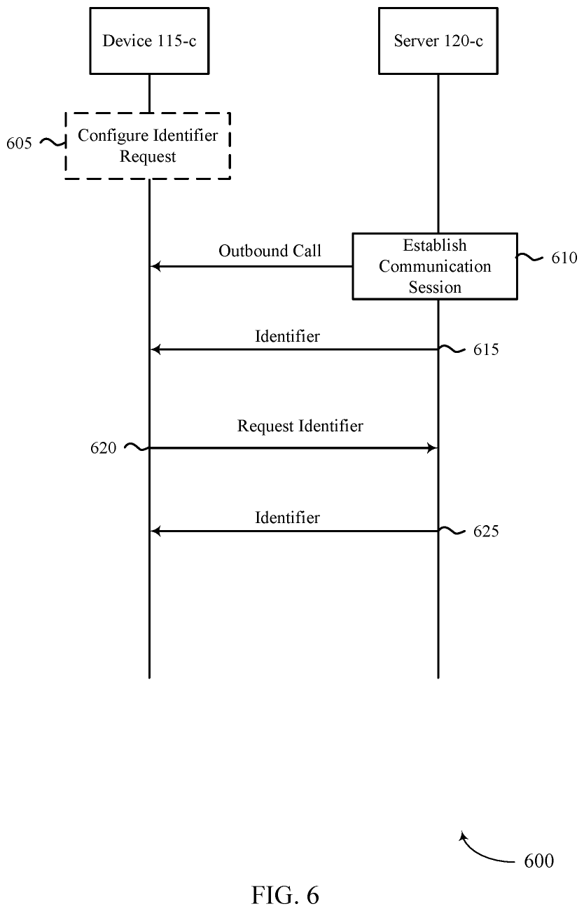

FIG. 6 illustrates an example of a process flow 600 that supports techniques for verifying a sender identity using a user-generated identifier in accordance with one or more aspects of the present disclosure. The process flow 600 or aspects thereof may be implemented by a device 115-c associated with a user (e.g., a user 105) and by a server 120-c associated with an organization (e.g., an organization 110), which may each be examples of the corresponding entities as described with reference to FIGS. 1 through 5. For example, the device 115-c may be an example of one or more devices 115, a device 115-a, a device 300, a device 400, or a device 115-b, as described with reference to FIGS. 1 through 5. The server 120-c may be an example of a server 120, a server 120-a, or a server 120-b described with reference to FIG. 1, 2 or 3. In some aspects, the server 120-c may provide functionality for, or support aspects of, a system managed by an organization. In the following description of the process flow 600, the operations may be performed in a different order than the order shown. For example, specific operations may also be left out of the process flow 600, or other operations may be added to process flow 600.

The process flow 600 may illustrate a method for the user to verify the identity of the organization as part of an outbound call (e.g., a telephone call to the device 115-c) from a representative of the organization, such as the representative 135. In some examples, at 605, the user may, using an application managed by the server 120-c (e.g., an application 405), configure one or more account settings to request to receive a unique identifier associated with the user as part of communications associated with one or more accounts of the user from the representative.

Accordingly, as part of establishing a communication session at 610, a representative of the organization may initiate an outbound call to the device 115-c (e.g., using an automated dialing system or dial-assisted call system). In some cases, at 615, the server 120-c may transmit the unique identifier to the device 115-c using a same communication channel as the communication session. For example, if the unique identifier includes an audio message, the server 120-c may play the audio file as part of establishing the communication session at 610 (e.g., upon the device 115-c answering the outbound call).

Additionally, or alternatively, the server 120-c may transmit the unique identifier to the device 115-c using a communication channel different than the communication channel used for the communication session. For example, if the user has requested to receive the unique identifier (e.g., requested using one or more profile or account settings at 605) as part of outbound calls, the server 120-c may transmit the unique identifier to the device 115-c at 615 using a message, such as an MMS message, an SMS message, a push notification, or a combination thereof.

In some cases, a user may, at 620, request the unique identifier during the communication session, for example as part of the telephone call between the representative and the user. In such cases, at 625, the server 120-c may support transmitting the unique identifier to the device 115-c using a message, such as an MMS message, an SMS message, a push notification, or a combination thereof. To enhance security of the unique identifier, the server 120-c may not display the unique identifier to the representative. For example, the server 120-c may provide a function to the representative to transmit the unique identifier, without revealing the unique identifier to the representative. Accordingly, the representative may execute the function using the server 120-c to transmit the unique identifier to the device 115-c.

FIG. 7 illustrates a system 700 including a device 705 that supports techniques for verifying a sender identity using a user-generated identifier in accordance with one or more aspects of the present disclosure. The device 705 may include components for bi-directional voice and data communications including components for transmitting and receiving communications, such as an action response component 720, an input/output (I/O) controller 710, a database controller 715, a memory 725, a processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another operating system. Additionally, or alternatively, the I/O controller 710 may represent or interact with a modem, a keyboard, a mouse, a touchscreen, or a similar device. In some cases, the I/O controller 710 may be implemented as part of a processor. In some examples, a user may interact with the device 705 via the I/O controller 710 or via hardware components controlled by the I/O controller 710.

The database controller 715 may manage data storage and processing in a database 735. The database 735 may be external to the device 705, temporarily or permanently connected to the device 705, or a data storage component of the device 705. In some cases, a user may interact with the database controller 715. In some other cases, the database controller 715 may operate automatically without user interaction. The database 735 may be an example of a persistent data store, a single database, a distributed database, multiple distributed databases, a database management system, or an emergency backup database.

Memory 725 may include random-access memory (RAM) and read only memory (ROM). The memory 725 may store computer-readable, computer-executable software including instructions that, when executed, cause the processor to perform various functions described herein. In some cases, the memory 725 may contain, among other things, a BIOS which may control basic hardware or software operation such as the interaction with peripheral components or devices.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In some other cases, a memory controller may be integrated into the processor 730. The processor 730 may be configured to execute computer-readable instructions stored in memory 725 to perform various functions (e.g., functions or tasks supporting techniques for verifying a sender identity using a user-generated identifier).

For example, the action response component 720 may be configured as or otherwise support a means for receiving, by a system managed by a system (e.g., the system 700), a unique identifier generated by a user and provided via a device (e.g., a smartphone, a tablet, a laptop computer, or the like) associated with the user, the user having one or more accounts associated with the organization. The action response component 720 may be configured as or otherwise support a means for establishing a communication session between the organization and the user. The action response component 720 may be configured as or otherwise support a means for generating, by the system and as part of the communication session, a message associated with the one or more accounts provided by the organization. The action response component 720 may be configured as or otherwise support a means for embedding the unique identifier into the message. The action response component 720 may be configured as or otherwise support a means for transmitting, as part of the communication session, the message to the device associated with the user.

Additionally, or alternatively, the action response component 720 may be configured as or otherwise support means for generating, by a system (e.g., the system 700) managed by an organization, a unique identifier associated with a user, the user having one or more accounts associated with the organization, where the unique identifier is automatically generated in response to a request received at the system from a device associated with the user. The action response component 720 may be configured as or otherwise support a means for establishing a communication session between the organization and the user. The action response component 720 may be configured as or otherwise support a means for generating, by the system and as part of the communication session, a message associated with the one or more accounts provided by the organization. The action response component 720 may be configured as or otherwise support a means for embedding the unique identifier into the message. The action response component 720 may be configured as or otherwise support a means for transmitting, as part of the communication session, the message to the device associated with the user.

By including or configuring the action response component 720 in accordance with examples as described herein, the device 705 may support techniques for verifying a sender identity using a user-generated identifier.

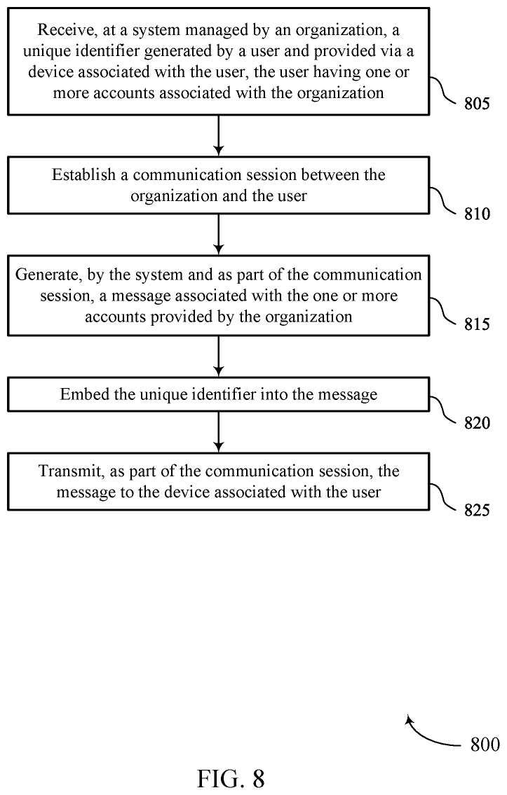

FIG. 8 illustrates a flowchart showing a method 800 that supports techniques for verifying a sender identity using a user-generated identifier in accordance with one or more aspects of the present disclosure. The operations of the method 800 may be implemented by a user generated identifier support system or its components as described herein. For example, the operations of the method 800 may be performed by a user generated identifier support system as described with reference to FIGS. 1 through 3. In some examples, a user generated identifier support system may execute a set of instructions to control the functional elements of the user generated identifier support system to perform the described functions. Additionally, or alternatively, the user generated identifier support system may perform aspects of the described functions using special-purpose hardware.

At 805, the method may include receiving, at a system managed by an organization, a unique identifier generated by a user and provided via a device associated with the user, the user having one or more accounts associated with the organization. The operations of 805 may be performed in accordance with examples as disclosed herein.

At 810, the method may include establishing a communication session between the organization and the user. The operations of 810 may be performed in accordance with examples as disclosed herein.

At 815, the method may include generating, by the system and as part of the communication session, a message associated with the one or more accounts provided by the organization. The operations of 815 may be performed in accordance with examples as disclosed herein.

At 820, the method may include embedding the unique identifier into the message. The operations of 820 may be performed in accordance with examples as disclosed herein.

At 825, the method may include transmitting, as part of the communication session, the message to the device associated with the user. The operations of 825 may be performed in accordance with examples as disclosed herein.

In some examples, an apparatus as described herein may perform a method or methods, such as the method 800. The apparatus may include features, circuitry, logic, means, or instructions (e.g., a non-transitory computer-readable medium storing instructions executable by a processor) for receiving, at a system managed by an organization, a unique identifier generated by a user and provided via a device associated with the user, the user having one or more accounts associated with the organization, establishing a communication session between the organization and the user, generating, by the system and as part of the communication session, a message associated with the one or more accounts provided by the organization, embedding the unique identifier into the message, and transmitting, as part of the communication session, the message to the device associated with the user.

Some examples of the method 800 and the apparatus described herein may further include operations, features, means, or instructions for transmitting, to the device associated with the user, a prompt for the unique identifier and receiving, from the device and in response to the prompt, an indication of a first identifier generated by the user, wherein the unique identifier comprises the first identifier.

Some examples of the method 800 and the apparatus described herein may further include operations, features, means, or instructions for determining that the first identifier may be unique among a plurality of identifiers stored in a database of the system, wherein the unique identifier comprises the first identifier based at least in part on the first identifier being unique.

Some examples of the method 800 and the apparatus described herein may further include operations, features, means, or instructions for transmitting, to the device associated with the user, a first prompt for the unique identifier, receiving, from the device and in response to the first prompt, an indication of a first identifier generated by the user, transmitting, to the device, an indication that the first identifier may be not unique based at least in part on a comparison of the first identifier with a plurality of identifiers stored in a database of the system, wherein the indication that the first identifier may be not unique comprises a second prompt for the unique identifier, and receiving, from the device and in response to the second prompt, a second identifier generated by the user, the second identifier being different from the first identifier, wherein the unique identifier embedded into the message comprises the second identifier based at least in part on the second identifier being unique among the plurality of identifiers stored in a database of the system.

Some examples of the method 800 and the apparatus described herein may further include operations, features, means, or instructions for embedding an additional identifier associated with the organization into the unique identifier, wherein the message comprises the unique identifier with the embedded additional identifier.

Some examples of the method 800 and the apparatus described herein may further include operations, features, means, or instructions for receiving, at the system, a second unique identifier generated by the user and provided via the device, the second unique identifier being different than the unique identifier and associating the second unique identifier with at least one account of the one or more accounts.

Some examples of the method 800 and the apparatus described herein may further include operations, features, means, or instructions for generating, by the system and as part of the communication session, one or more additional messages associated with the one or more accounts after transmitting the message and transmitting the one or more additional messages to the device associated with the user, wherein the one or more additional messages exclude the unique identifier.

Some examples of the method 800 and the apparatus described herein may further include operations, features, means, or instructions for providing, as part of an outbound call associated with the communication session, an indication that the user may have requested that the message comprising the unique identifier be provided by a representative of the organization, wherein the communication session comprises communications between the representative and the user, and wherein the message may be transmitted in response to the provided indication.

Some examples of the method 800 and the apparatus described herein may further include operations, features, means, or instructions for determining that a threshold duration after identifying the unique identifier may have been satisfied and transmitting, to the device associated with the user, a request message comprising an indication to modify the unique identifier.

Some examples of the method 800 and the apparatus described herein may further include operations, features, means, or instructions for configuring the threshold duration of based at least in part on an input from the user.

In some examples of the method 800 and the apparatus described herein, the message comprises an MMS message, an SMS message, push notification, or any combination thereof.

In some examples of the method 800 and the apparatus described herein, the unique identifier comprises a phrase, a code, a pictogram, an image, an audio message recorded by the user, or any combination thereof.

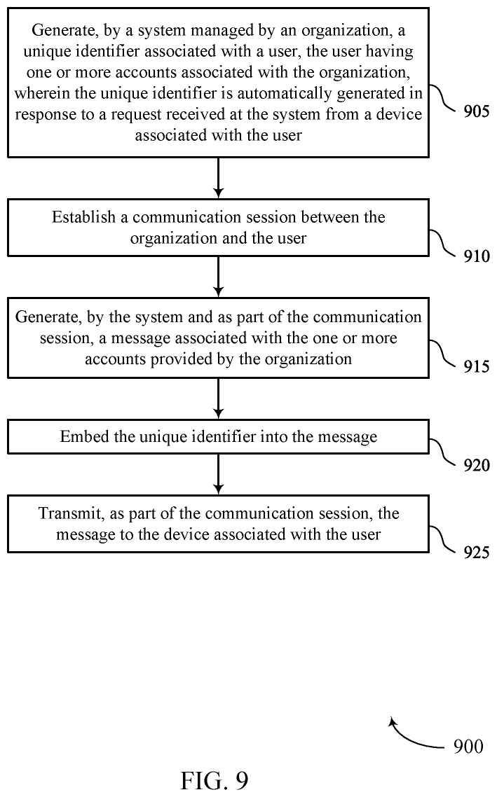

FIG. 9 illustrates a flowchart showing a method 900 that supports techniques for verifying a sender identity using a user-generated identifier in accordance with one or more aspects of the present disclosure. The operations of the method 900 may be implemented by a user generated identifier support system or its components as described herein. For example, the operations of the method 900 may be performed by a user generated identifier support system as described with reference to FIGS. 1 through 3. In some examples, a user generated identifier support system may execute a set of instructions to control the functional elements of the user generated identifier support system to perform the described functions. Additionally, or alternatively, the user generated identifier support system may perform aspects of the described functions using special-purpose hardware.

At 905, the method may include generating, by a system managed by an organization, a unique identifier associated with a user, the user having one or more accounts associated with the organization, wherein the unique identifier is automatically generated in response to a request received at the system from a device associated with the user. The operations of 905 may be performed in accordance with examples as disclosed herein.

At 910, the method may include establishing a communication session between the organization and the user. The operations of 910 may be performed in accordance with examples as disclosed herein.

At 915, the method may include generating, by the system and as part of the communication session, a message associated with the one or more accounts provided by the organization. The operations of 915 may be performed in accordance with examples as disclosed herein.

At 920, the method may include embedding the unique identifier into the message. The operations of 920 may be performed in accordance with examples as disclosed herein.

At 925, the method may include transmitting, as part of the communication session, the message to the device associated with the user. The operations of 925 may be performed in accordance with examples as disclosed herein.

In some examples, an apparatus as described herein may perform a method or methods, such as the method 900. The apparatus may include features, circuitry, logic, means, or instructions (e.g., a non-transitory computer-readable medium storing instructions executable by a processor) for generating, by a system managed by an organization, a unique identifier associated with a user, the user having one or more accounts associated with the organization, wherein the unique identifier is automatically generated in response to a request received at the system from a device associated with the user, establishing a communication session between the organization and the user, generating, by the system and as part of the communication session, a message associated with the one or more accounts provided by the organization, embedding the unique identifier into the message, and transmitting, as part of the communication session, the message to the device associated with the user.

In some examples of the method 900 and the apparatus described herein, generating the unique identifier may include operations, features, circuitry, logic, means, or instructions for randomly generating the unique identifier such that the unique identifier may be different from a plurality of other identifiers stored in a database of the system.

In some examples of the method 900 and the apparatus described herein, generating the unique identifier may include operations, features, circuitry, logic, means, or instructions for generating a plurality of unique identifiers that may be each different from a plurality of other identifiers stored in a database of the system, the method further comprising, transmitting, to the device, a first message including an indication of the plurality of unique identifiers, and receiving, from the device, a second message indicating a selection of a first unique identifier from the plurality of unique identifiers, wherein the unique identifier embedded into the message comprises the first unique identifier based at least in part on receiving the second message indicating the selection.

Some examples of the method 900 and the apparatus described herein may further include operations, features, means, or instructions for transmitting, to the device, a first message including an indication of the unique identifier generated by the system and receiving, from the device, a second message indicating that the unique identifier may be accepted by the user, wherein the unique identifier may be embedded into the message based at least in part on receiving the second message indicating that the unique identifier may be accepted by the user.

Some examples of the method 900 and the apparatus described herein may further include operations, features, means, or instructions for transmitting, to the device, a first message including an indication of a first unique identifier generated by the system, the first unique identifier being unique among a plurality of other identifiers stored in a database of the system, receiving, from the device, a second message indicating that the unique identifier may be not accepted by the user, transmitting, to the device and in response to the second message, a third message including an indication of a second unique identifier generated by the system, the second unique identifier being different from the first unique identifier and being unique among the plurality of other identifiers stored in the database of the system, and receiving, from the device, a fourth message indicating that the second unique identifier may be accepted by the user, wherein the unique identifier embedded into the message comprises the second unique identifier based at least in part on the fourth message indicating that the second unique identifier may be accepted by the user.

Some examples of the method 900 and the apparatus described herein may further include operations, features, means, or instructions for receiving the request from the device based at least in part on one or more failed attempts by the user to generate the unique identifier.

Some examples of the method 900 and the apparatus described herein may further include operations, features, means, or instructions for receiving the request from the device based at least in part on establishing at least one of the one or more accounts by the organization.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for techniques for verifying a sender identity using a user-generated identifier (e.g., a user-generated unique identifier).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
receiving, at a system managed by an organization, a unique identifier generated by a user and provided via a device associated with the user, the user having one or more accounts associated with the organization;
establishing a communication session between the organization and the user;
generating, by the system and as part of the communication session, a message associated with the one or more accounts provided by the organization;
embedding the unique identifier into the message; and
transmitting, as part of the communication session, the message to the device associated with the user.

2. The method of claim 1, further comprising:
transmitting, to the device associated with the user, a prompt for the unique identifier; and
receiving, from the device and in response to the prompt, an indication of a first identifier generated by the user, wherein the unique identifier comprises the first identifier.

3. The method of claim 2, further comprising:
determining that the first identifier is unique among a plurality of identifiers stored in a database of the system, wherein the unique identifier comprises the first identifier based at least in part on the first identifier being unique.

4. The method of claim 1, further comprising:
transmitting, to the device associated with the user, a first prompt for the unique identifier;
receiving, from the device and in response to the first prompt, an indication of a first identifier generated by the user;
transmitting, to the device, an indication that the first identifier is not unique based at least in part on a comparison of the first identifier with a plurality of identifiers stored in a database of the system, wherein the indication that the first identifier is not unique comprises a second prompt for the unique identifier; and
receiving, from the device and in response to the second prompt, a second identifier generated by the user, the second identifier being different from the first identifier, wherein the unique identifier embedded into the message comprises the second identifier based at least in part on the second identifier being unique among the plurality of identifiers stored in a database of the system.

5. The method of claim 1, further comprising:
embedding an additional identifier associated with the organization into the unique identifier, wherein the message comprises the unique identifier with the embedded additional identifier.

6. The method of claim 1, further comprising:
receiving, at the system, a second unique identifier generated by the user and provided via the device, the second unique identifier being different than the unique identifier; and
associating the second unique identifier with at least one account of the one or more accounts.

7. The method of claim 1, further comprising:
generating, by the system and as part of the communication session, one or more additional messages associated with the one or more accounts after transmitting the message; and
transmitting the one or more additional messages to the device associated with the user, wherein the one or more additional messages exclude the unique identifier.

8. The method of claim 1, further comprising:
providing, as part of an outbound call associated with the communication session, an indication that the user has requested that the message comprising the unique identifier be provided by a representative of the organization, wherein the communication session comprises communications between the representative and the user, and wherein the message is transmitted in response to the provided indication.

9. The method of claim 1, further comprising:
determining that a threshold duration after identifying the unique identifier has been satisfied; and
transmitting, to the device associated with the user, a request message comprising an indication to modify the unique identifier.

10. The method of claim 9, further comprising:
configuring the threshold duration of based at least in part on an input from the user.

11. The method of claim 1, wherein the message comprises a multimedia messaging service (MMS) message, a short message/messaging service (SMS) message, push notification, or any combination thereof.

12. The method of claim 1, wherein the unique identifier comprises a phrase, a code, a pictogram, an image, an audio message recorded by the user, or any combination thereof.

13. A method, comprising:
generating, by a system managed by an organization, a unique identifier associated with a user, the user having one or more accounts associated with the organization, wherein the unique identifier is automatically generated in response to a request received at the system from a device associated with the user;
establishing a communication session between the organization and the user;
generating, by the system and as part of the communication session, a message associated with the one or more accounts provided by the organization;
embedding the unique identifier into the message; and
transmitting, as part of the communication session, the message to the device associated with the user.

14. The method of claim 13, wherein generating the unique identifier comprises:
randomly generating the unique identifier such that the unique identifier is different from a plurality of other identifiers stored in a database of the system.

15. The method of claim 13, wherein generating the unique identifier comprises:
generating a plurality of unique identifiers that are each different from a plurality of other identifiers stored in a database of the system, the method further comprising:
transmitting, to the device, a first message including an indication of the plurality of unique identifiers; and
receiving, from the device, a second message indicating a selection of a first unique identifier from the plurality of unique identifiers, wherein the unique identifier embedded into the message comprises the first unique identifier based at least in part on receiving the second message indicating the selection.

16. The method of claim 13, further comprising:
transmitting, to the device, a first message including an indication of the unique identifier generated by the system; and
receiving, from the device, a second message indicating that the unique identifier is accepted by the user, wherein the unique identifier is embedded into the message based at least in part on receiving the second message indicating that the unique identifier is accepted by the user.

17. The method of claim 13, further comprising:
transmitting, to the device, a first message including an indication of a first unique identifier generated by the system, the first unique identifier being unique among a plurality of other identifiers stored in a database of the system;
receiving, from the device, a second message indicating that the unique identifier is not accepted by the user;
transmitting, to the device and in response to the second message, a third message including an indication of a second unique identifier generated by the system, the second unique identifier being different from the first unique identifier and being unique among the plurality of other identifiers stored in the database of the system; and
receiving, from the device, a fourth message indicating that the second unique identifier is accepted by the user, wherein the unique identifier embedded into the message comprises the second unique identifier based at least in part on the fourth message indicating that the second unique identifier is accepted by the user.

18. The method of claim 13, further comprising:
receiving the request from the device based at least in part on one or more failed attempts by the user to generate the unique identifier.

19. The method of claim 13, further comprising:
receiving the request from the device based at least in part on establishing at least one of the one or more accounts by the organization.

20. An apparatus, comprising:
a processor;
memory coupled with the processor; and
instructions stored in the memory and executable by the processor to cause the apparatus to:
receive, at a system managed by an organization, a unique identifier generated by a user and provided via a device associated with the user, the user having one or more accounts associated with the organization;
establish a communication session between the organization and the user;
generate, by the system and as part of the communication session, a message associated with the one or more accounts provided by the organization;
embed the unique identifier into the message; and
transmit, as part of the communication session, the message to the device associated with the user.
